(19) United States
(12) Patent Application Publication
(10) Pub. No.: US 2007/0265712 A1
(43) Pub. Date: Nov. 15, 2007

(54) Instrumentation that serves data over the Internet

(76) Inventors: Daniel Leontiev, Cerritos, CA (US); Stefan Serban Nastase, Fontana, CA (US); Steven Hollander, Los Angeles, CA (US)

Correspondence Address: WILLIAM ANTHONY DRUCKER, Unit #208, 610 N. West Street, Alexandria, VA, 22314, US

(21) Appl. No.: 11/879,886

(22) Filed: Jul. 18, 2007

Related U.S. Application Data
(63) Continuation-in-part of application No. 09/929,039, filed on Aug. 15, 2001, now abandoned.
(60) Provisional application No. 60/252,899, filed on Nov. 27, 2000.

(51) Int. Cl. G05B 19/18

(52) U.S. Cl. 700/3

(57) ABSTRACT

The invention relates to instruments and methods for controlling operation of remote industrial equipment and process by detected data transfer via internet to an operator located away from the operation who manages variable parameters of the equipment or process via internet control.

### CROSS REFERENCE TO RELATED APPLICATIONS

This application is a continuation-in-part of Applicants' co-pending application U.S. Ser. No. 09/929,039 filed on Aug. 15, 2001, which claims benefit from Ser. No. 60/262,899 of Nov. 27, 2000.

### FIELD OF THE INVENTION

The invention relates to instruments and apparatus, such as controllers, panel meters, transmitters, signal conditioners, paperless data recorders, and the like, for use in test and measurement, process control, and industrial automation. The invention provides a system of apparatus and to a method whereby information derived from instrumentation which monitors, and if need be controls, for example, industrial machinery plant or processes, is passed via the Internet/Ethernet to a supervisor, operator or to a supervising instrumentation control station. Conversely, instructions for modifying the operation of instruments or apparatus are passed from a supervisor or from supervising instrumentation via the Internet/Ethernet to devices, which monitor or control the plant or process, thereby providing a feedback system, which stabilizes operation. Provision is made for each item of monitoring or control instrumentation to be provided with a distinct or different Internet/Ethernet address.

It is possible to connect microprocessor based instruments used for test and measurement, monitoring and controlling industrial machinery, plant and process control and automation, to a single computer by serial communications, such RS 232 or RS 486. The computer is the “master” to the instrument “slaves” when the computer is running appropriate software and is equipped with hardware components and software necessary for networking, and the instruments are visible/accessible over a network, such as a Local Area Ethernet Network (LAN), a Wide Area Network (WAN), or the Internet. “Accessible” means that data can be viewed, and settings changed, e.g., changing set points or alarm points as needed, so that the operator is not physically in front of the instrument or controller, but functions from a remote position computer terminal, either fixed or hand-held, such as a wireless cell phone. The computer serves as the “master” to one or multiple “slave” instruments, which are nodes or stations on a network. A LAN is separated from the Internet by a “firewall” to provide security from the outer world.

The LAN is similar to a telephone system which may have an internal PBX connected to the world in which individual extensions are connected via a switch. Internet/Ethernet devices or computers are characterized by an IP (Internet Protocol) number or name, as well as by a MAC (Media Access Control) address. By analogy, automobiles have a VIN (vehicle identification number) assigned by a manufacturer, as well as a License number which changes from owner to owner.

In the industry, such a network is known and addresses the issue of accessibility, by using a common language/protocol for a variety of device such as monitors, controllers and valves or switches. An “open” system is also used to allow an operator alternatively to access the same information, even for different reasons, each access without disturbing one another. A difficulty has been to connect a device to a computer ready connected to a network and to software appropriate to a particular application. The computer is a bridge or link between a particular device and a network with which it communicates via a serial port. The computer is also a “server” for other computers on the network, collecting data from the device and translating commands. Various types of computer such as desktop, laptop or large central server are used and some are bulky or expensive.

### OBJECTS OF THE INVENTION

An object of the invention is to provide a system, for use in the operation, supervision and/or control of apparatus, such as industrial processing equipment, or processes, which provides a link between devices and a remote control site such as a control room, supervisor office or mobile station in a vehicle, by linkage via internet connection.

Another object of the invention is to provide means for a remote operator to receive information from a device, and to send instruction to such a device to change the operation or assess performance of the device via Internet, and even to effect this from a hand-held radio frequency control, such as a cell phone.

Another object of the invention is to provide remote control instruments which incorporate Net or Web server means which thereby avoid intermediary computer and web server apparatus.

Another object of the invention is to provide supervisory instrumentation adapted to transmit and/or receive E-mail information between a device and an operator or an alarm or display element, for example in management of variable temperature via hand held or radio frequency communication (e.g., a programmed cell phone).

### SUMMARY OF THE INVENTION

Instrumentation for monitoring, controlling and/or supervising an operation, such as an industrial operation, incorporates means, which when placed on-line provides internet connection with apparatus for supervision and control, enabling the operation to be managed from a remote location.

Instrumentation comprises web server means enabling direct connection to the Internet to transmit data and to receive instruction via TCP/IP protocol. A supervisor or robot can monitor and control a process through a web browser from any location via Internet and may operate by wireless connection.

Instrumentation for process monitoring and control may be provided with means preparing and transmitting information by E-mail for reception on a web enabled pager or on a cell phone.

Instrumentation of the invention is illustrated by controllers for processes, panel meters, transmitters, signal conditioners, and by instruments for testing, measuring and/or monitoring factors or variable parameters such as DC or AC voltages/currents, power, temperature, time, strain, weight, pressure, torque, vibration, frequency, rate, speed, pulse counting, timing, pH, ORP, conductivity, and contact openings or closures signaling activities and alarms.

Receptor means are adapted to receive detected process factors from control means and to show measured information at a supervision site, for example on programmable color displays, which may be programmed to change color at a desired alarm value or set point. The display features of this invention are dynamic and vary as the process advances. The display feature is to be distinguished from the static control of a simple computer printer to indicate or to retrieve words or pictures from a computer, since the display indicates changes in measured parameters from a detector instrument which are then used by the method of the invention to change and manage the operation of a process by a remote operator or robot from instructions sent to the operation over a network. Reception of data and dispatch of instruction may come via a wireless hand held device such as a cell phone.

Monitoring apparatus is provided with industry standard RJ-46 connection enabled to send and to receive data in standard TCP/IP packages.

A 1/16 DIN temperature controller controls a heater, so an operator can monitor temperature, change set points and alarm points, turn the heater “on” or “off” and modify function from anywhere on a network. Web pages are customized and pass word secure to protect access to controls.

Apparatus of the invention is assigned an IP address on the network, which may be a name such as “heater #3”.

Apparatus may also have an authorized internet IP address from an internet service provider and function as a World Wide Web server to deliver required specific information.

Internet connection capability is incorporated in a discreet DIN rail mounted device which may have a hub connecting multiple devices with communication to the internet or network.

The server may be both a Web server and an Ethernet-Serial Bridge compatible with RS-422 and RS-486.

The invention provides an embedded web server and memory to store specific web pages and to replace the computer.

In practice one embeds essential software or firm ware for communicating over a network in TCP/IP and serving Web pages in the memory of the instrument's microprocessor. A second micro-processor works in tandem with a primary micro-processor. An Ethernet driver in the circuit connects directly to the network. When an optional RS-486 driver is in place the instrument is a hub allowing a user to access multiple devices through a single network connection and one IP address without other software. Once on network web pages are accessed from a personal computer with a standard web browser by entry of an IP number or name assigned to the server. The internet thus becomes an instrumentation circle and offers an open system, without proprietary software, accessible to anyone. Security levels and passwords enhance the system.

### BRIEF DESCRIPTION OF THE DRAWING

In the Drawing:

FIG. 1 is a block diagram showing features of the invention;

FIG. 2 shows link up arrangements for a temperature controller having network provided operational capacity;

FIG. 3 is a block diagram illustrating in descriptive terms essentials of construction and operation of a system of remote supervision and control of an industrial operation;

FIG. 4 is a schematic lay out of a system utilizing commercially available 1/8 DIN controller as a HUB for up to thirty two devices.

FIG. 5 is a schematic layout of another configuration for direct connection of a panel meter or controller to the Ethernet via a 10 Base-T RJ-45 connector.

FIG. 6 “A” shows a cartoon diagram of two devices connected over the internet. The first device in this example is a digital panel meter that measures temperature, a thermometer. The device uses a temperature sensor such as a thermocouple or RTD, resistance temperature detector. The meter measures milli-volts or resistance which varies with temperature and converts the analogue signal to digital data. Data is displayed by LED's to show 451 degrees F, for example. The device is a node on the internet. It comprises a physical layer and a data link layer to enable it to be a node and to serve data packets directly over the network. It has a unique MAC address and unique IP address. the second device is a remote display. It is also a node with unique addresses. The first device transmits over the network (INTERNET) a data packet with the information “451 degrees F” directly to the second device. The second device displays transmitted data.

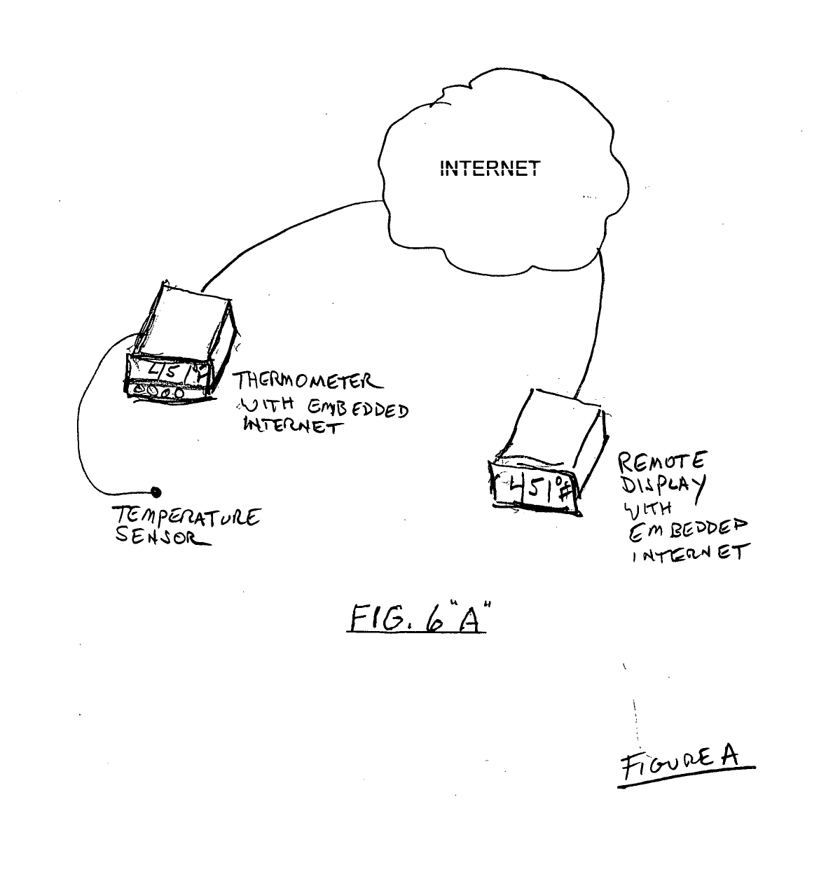

FIG. 7 “B” shows a cartoon diagram of an internet enabled meter transmitting data through a cell phone enabled network to a web enabled wireless device. The meter measures temperature and is a web server. The wireless device is a web client comprising a HTML internet browser. The wireless device requests a web page from meter which serves HTML web pages in standard internet HTTP (hypertext transfer protocol). The Web page displayed on the LCD screen of the wireless device presents the data served by the internet enabled meter, in this case 451 degrees F.

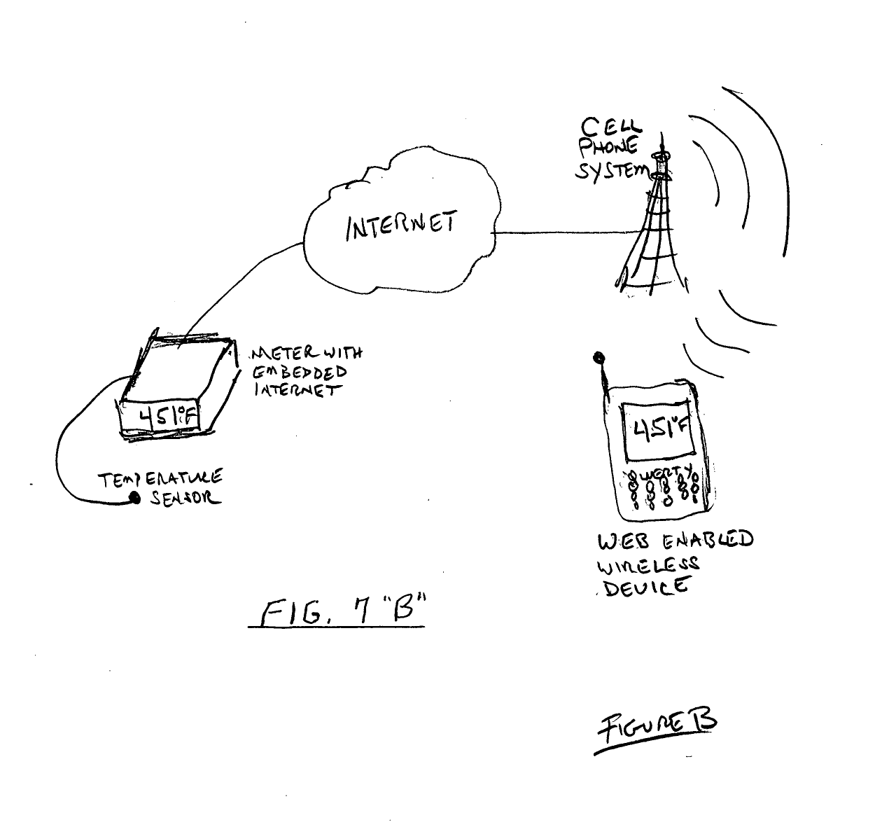

FIG. 8 “C” shows a cartoon diagram of an internet enabled wireless co-coordinator serving Web pages over the Internet to a personal computer. The co-coordinator is a node on the Internet which transmits or serves data collected from wireless sensors and receives radio transmission from AC or battery powered devices.

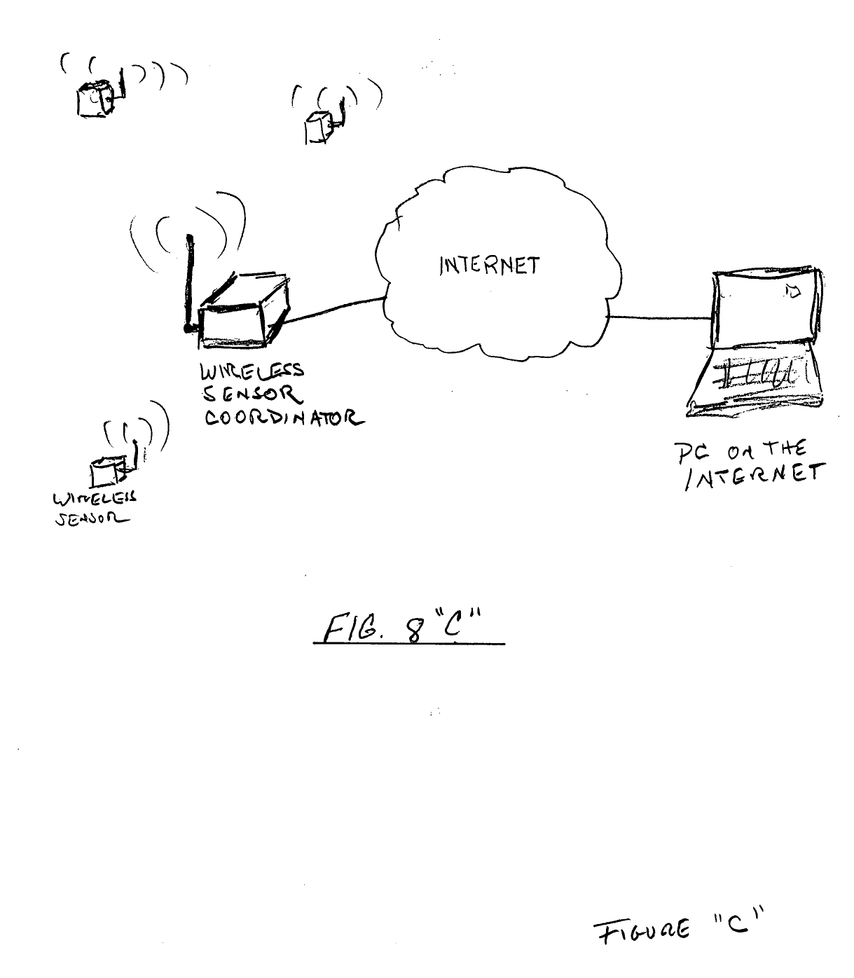

### DESCRIPTION OF PREFERRED EMBODIMENTS

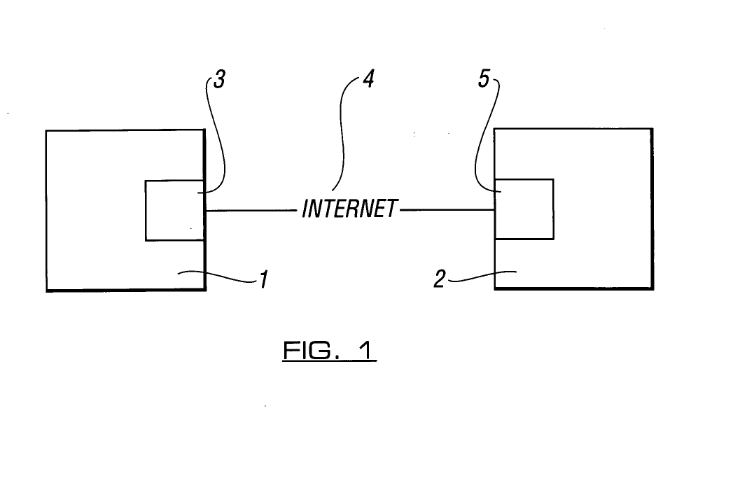

Referring to FIG. 1 of the Drawing, a device 1 such as a control for an industrial process is operated and/or supervised from a distant location 2, such as an instrument bank or supervisor's desk. The device 1, has incorporated in it a server 3 which is linked to the internet 4. This instrument bank or supervisor's desk at location 2 has incorporated in it known computer apparatus 6 providing connection to and from the internet 4. The supervisor may be at a remote location, and nevertheless, be able both to supervise and to control the process, as the case may be.

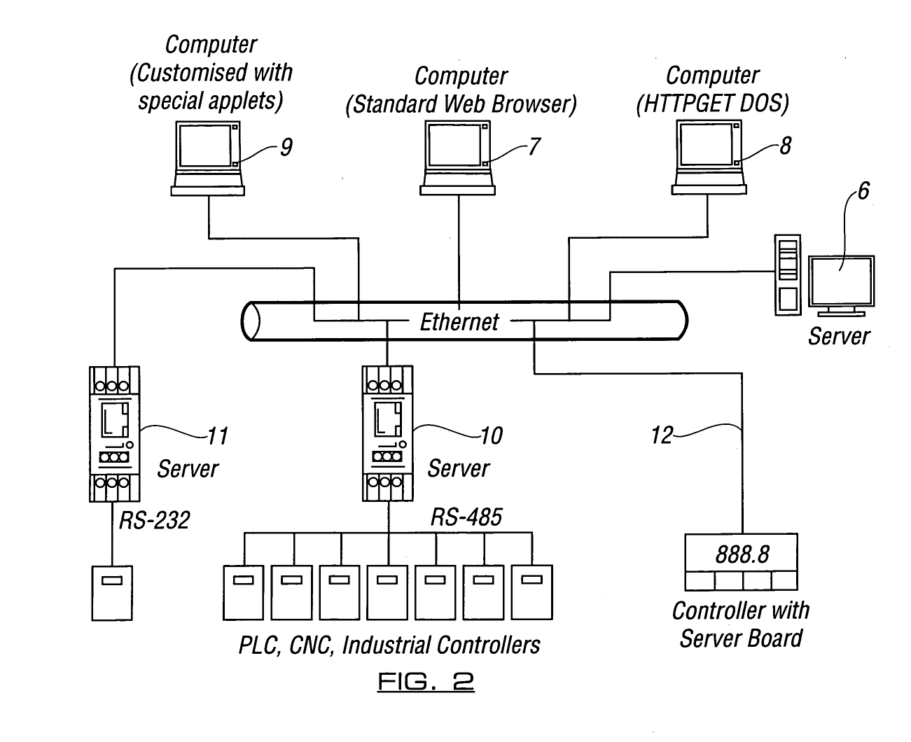

Referring to FIG. 2, there is shown a link-up arrangement for a temperature controller having internet-provided operational facility. The controller may be used as a stand alone DIN rail mounting unit, or as a portable monitor/controller.

In FIG. 2, the server 6 is constructed to connect industrial devices with serial interfaces to the Ethernet Network, using TCP/IP protocol. It comprises a Web server, and RS-232/485 interfaces. With this construction it is possible to make up the following arrangements:

(a) Use computer 7 with standard Web Browser (TCP/IP protocol) or a computer 8 with HTTPGET DOS program for network connectivity;

(b) Install via RS-232/485 serial port connection;

(c) Transfer data a from RS-232/485 serial interface to TCP/IP using a built in socket server;

(d) Use a computer 9 with a standard home page or customized web page using special applets, which can be made available on a prepared web site.

FIG. 2 of the Drawing shows how to connect the device with serial interfaces on the Net, using apparatus having server means, as set 10, 11 and 12.

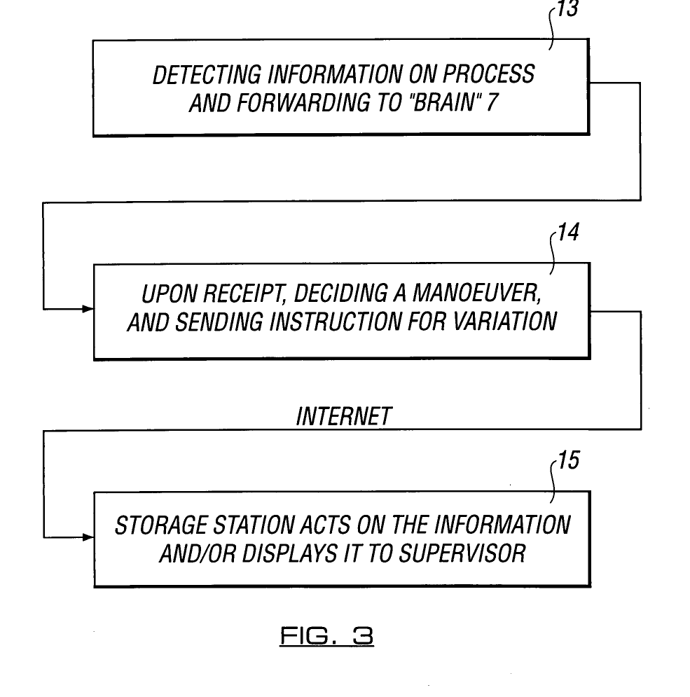

Referring to FIG. 3 of the Drawing, the block diagram shows monitoring and control equipment 13 install at the operation site, e.g., a manufacturing process, which it is desired to monitor and to control from a remote location. Monitoring and control equipment 13 is connected to a “brain” apparatus 14 likewise situated at the operation site and which, upon receipt of information from the monitoring and control equipment 13, decides upon a desired or essential change of operating conditions, e.g., to increase or to decrease a parameter of the manufacturing process. Information is then passed, via the internet, to a storage station 15 which retrieves the information and either acts upon it, or displays it to a supervisor, as the case may be. If change of operating conditions is necessary, then revised “instructions” are sent in the reverse direction, again via the internet, to the detecting and control system 6 which effects appropriate changes.

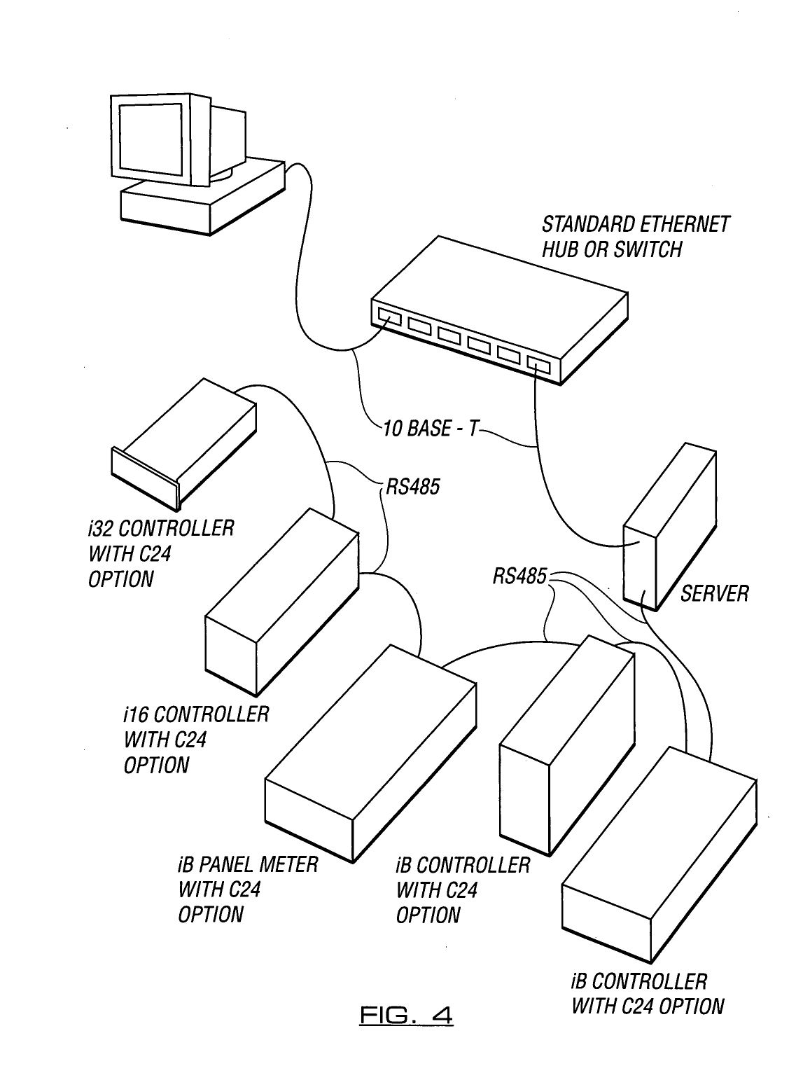

Referring to FIG. 4 of the Drawing, there is a schematic lay out of a system utilizing a 1/8 DIN controller, manufactured and distributed commercially in the United States, as a hub for up to 32 devices.

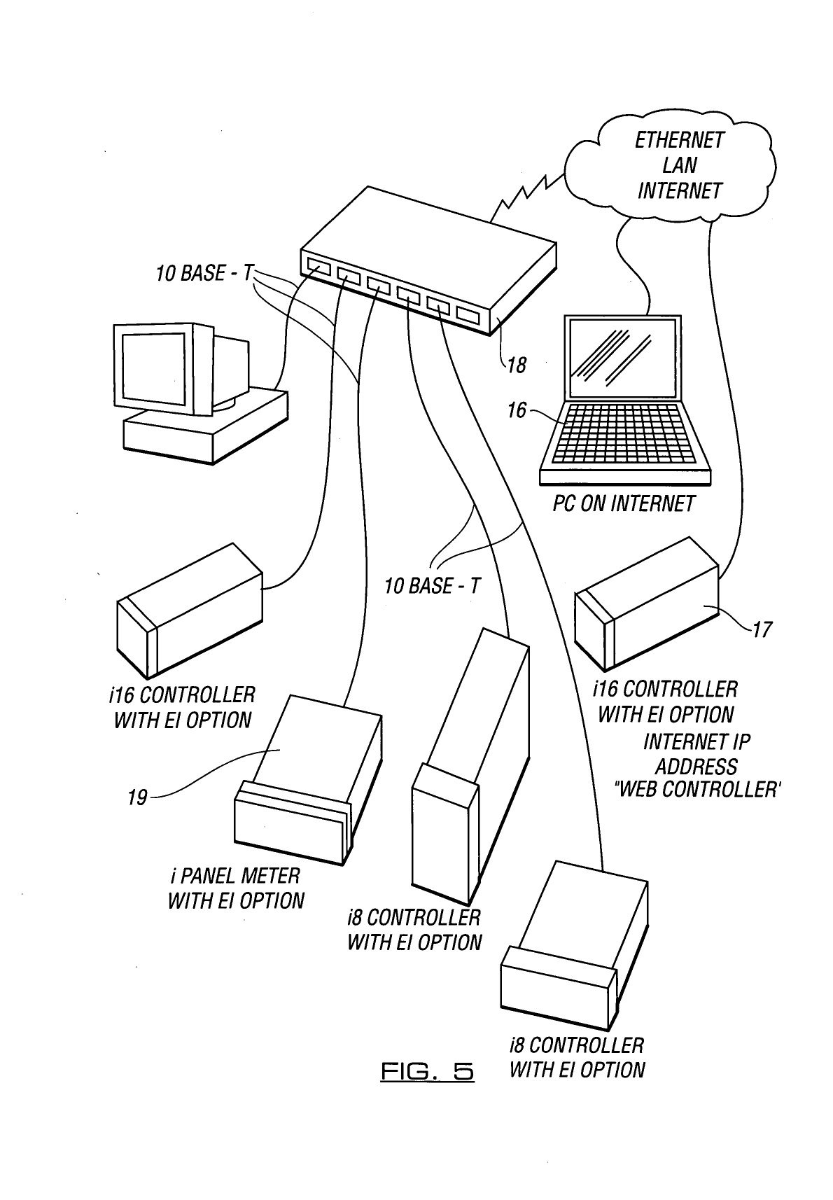

Referring to FIG. 5 of the Drawing, there is shown a configuration which uses a lap top computer 16, or an i-16 controller 17 with EL option, which can be connected, via the Internet, with a standard Ethernet hub or switch 18. This allows the 1/8 DIN and 1/16 DIN instruments to function as stand alone web servers having unique addresses if preferred.

1. Apparatus for monitoring, recording, and controlling variable parameters such as temperature, humidity, time, pH, weight, pressure, flow, electrical resistance, voltage and current through a direct connection to the internet.

2. Apparatus selected from meters, controllers, transmitters, signal conditioners and recorder and displays with embedded capacity to serve Web pages to computers and devices with web browsing capacity.

3. Apparatus as claimed in claim 1 which is an independent node on an Ethernet/Internet network which functions as server or client on said network.

4. Apparatus of claim 1 which transmits E-mail on the internet to control devices, to report device status or to indicate alarm conditions.

5. Apparatus of claim 1 which receives internet E-mail instruction and control.

6. Apparatus of claim 1 which displays temperature or weight via internet on a wireless enabled device or a meter display.

7. Thermostat apparatus activated by E-mail which displays and controls temperature remotely by E-mail.

8. A method of operating apparatus from a remote station via internet which comprises (a) feeding information data from a detector at said apparatus to a web server (b) transmitting said data via internet to control or operate a remote process or device (c) displaying said data.
